(19) United States
(12) Patent Application Publication
(10) Pub. No.: US 2006/0067691 A1
(43) Pub. Date: Mar. 30, 2006

(54) Communication system

(76) Inventors: Kenichi Hirano, Fukuoka (JP); Kazuhiro Uchida, Fukuoka (JP); Katsuhiko Hirashima, Fukuoka (JP); Masamichi Kasa, Fukuoka (JP)

Correspondence Address: KATTEN MUCHIN ROSENMAN LLP, 575 MADISON AVENUE, NEW YORK, NY, 10022-2585, US

(21) Appl. No.: 11/271,689

(22) Filed: Nov. 10, 2005

Related U.S. Application Data
(63) Continuation of application No. PCT/JP03/09219, filed on Jul. 18, 2003.

(51) Int. Cl. H04J 14/00

(52) U.S. Cl. 398/71

(57) ABSTRACT

A communication system is provided for preventing delivery of unnecessary packets to a user terminal and thereby improving transmission efficiency. In the communication system, an OLT communication interface transfers packets between a local office and a subscriber or transmits filter-setting data and receives filter-state data. An ONU communication interface transfers packets between the local office and the subscriber or receives the filter-setting data and transmitting the filter-state data. A terminal address managing unit obtains and manages a terminal address from a connected terminal. A packet filter performs an operation of filtering packets transmitted from an optical line terminal with respect to the connected terminal on the basis of at least one of delivery information, registered information and the filter-setting data.

This application is a continuing application, filed under 35 U.S.C. §111(a), of International Application PCT/JP2003/009219, filed Jul. 18, 2003.

### BACKGROUND OF THE INVENTION

1. Field of the Invention

The present invention relates to a communication system, and more particularly to a communication system that is arranged to communicate between a local office and a subscriber.

2. Description of the Related Art

In recent years, optical subscriber systems are being introduced. Such a system realizes FTTH (Fiber to The Home) system in which a subscriber communication network is constructed using optical devices. In particular, PON (Passive Optical Network) system will be made more commercially available in near future, because PON system has a merit of reducing the cost of installing an optical fiber.

This kind of optical access system is an indispensable technique to supplying a mass communication service such as VOD (Video On Demand), CATV (Cable Television) or a fast computer communication at low cost. As such, this kind of optical system is under development as a new-generation backbone network.

FIG. 9 illustrates a summary of the optical access system. In an optical access system (PON system) 100, subscriber premises 110-1 to 110-n have their ONUs (Optical Network Units) 111-1 to 111-n that are located for optical burst transmissions. A local office 120 has an OLT (Optical Line Terminal) 121. The ONUs 111-1 to 111-n are connected with terminals 4 such as personal computers, respectively. The OLT 121 is connected with a switch 122 for switching a network with the OLT 121. The ONUs 111-1 to 111-n and the OLT 121 are connected with a star coupler 130.

The downstream information from the local office 120 to the subscriber premises 110-1 to 110-n is transmitted from one optical fiber to the star coupler 130 and finally to the branched optical fibers. The upstream information from the subscriber premises 110-1 to 110-n to the local office 120 travels over the branched optical fibers to the star coupler 130 and then goes through to a single optical fiber. That is, the optical access system 100 is configured as an optical branched access network in which a connection of one local office 120 to n ONUs 111-1 to 111-n through the star coupler 130 is realized.

As the foregoing type of optical access system, BPON (Broadband PON) for transferring fixed-length cells between the local office and the subscriber has been developed on the ATM (Asynchronous Transfer Mode) technology. It is standardized in ITU-T. It is classified into a symmetric system in which the transmission speed is 150 Mbps for upstream and downstream transmissions and an asymmetric system in which the transmission speed is 155 Mbps for upstream transmission and 620 Mbps for downstream transmission.

On the other hand, today, attention is focused on an optical access system called an EPON (Ethernet PON), which transfers packets on the Ethernet (Registered Trademark) between the local office and the subscriber. The EPON is being currently standardized in IEEE, in which system the transmission speed is 1 Gbps at maximum for upstream and downstream transmissions. (The PON at Gigabit level is also called a GEPO.)

The EPON has a merit that it does not need so complicated control as the BPON, reduces the ONU in size, and lowers the overall cost. Further, for a leased net service for an enterprise, the BPON may be often advantageous, while for the FTTH for domestic use, it is considered that the EPON that has a simpler mechanism and lowers the instrument cost is prevailing as a main stream of the optical access network, because the FTTH is mainly used as a best-effort internet connection in ordinary homes.

As the conventional PON system technology, it has been proposed that when transmitting packets downstream from an OLT to the ONU, the synchronous establishment is controlled for each cell so that if an out-of-synchronization takes place in a packet, the synchronization is established for quite a short time. (For example, refer to Japanese Unexamined Patent Publication No. 10-112718 (paragraph Nos. [0016] to [0021], FIG. 1))

Turning to the EPON being currently standardized, when variable-length packets are delivered on the Ethernet from the OLT to the ONUs, irrespective of the registering states of the ONUs, all the packets are transparently transmitted to all the connected terminals through the subscriber terminals. Hence, for a certain terminal, unnecessary packets that are not addressed to the terminal are delivered. In order to overcome this unfavorableness, the terminal executes the filtering operation so that the terminal permits only the packets destined for itself to pass to itself.

As described above, in the downstream transmission of the EPON, unnecessary packets are delivered down to the terminal side, so that unnecessary packets occupy a transmission band of the network between the ONU and the terminal, thereby disadvantageously making the transmission efficiency lower.

### SUMMARY OF THE INVENTION

In view of the foregoing, it is an object of the present invention to provide a communication system that is arranged to ameliorate the transmission efficiency by preventing unnecessary packets from being delivered down to the user terminal.

To accomplish the above object, the present invention provides a communication system for communicating information. This system comprises the following elements: an optical line terminal having an OLT communication interface for transferring packets between a local office and a subscriber or transmitting filter-setting data and receiving filter-state data; and an optical network unit having an ONU communication interface for transferring packets between the local office and the subscriber or receiving the filter-setting data and transmitting the filter-state data, a terminal address managing unit for obtaining and managing a terminal address from a connected terminal, and a packet filter for filtering packets transmitted from the optical line terminal with respect to the terminal based on at least one of delivery information, registered information, and the filter-setting data.

The above and other objects, features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 is a principle view showing a communication system according to the present invention.

FIG. 2 is a block diagram showing an arrangement of a first ONU.

FIG. 3 is a block diagram showing an arrangement of a second ONU.

FIG. 4 is a block diagram showing an arrangement of a first communication system.

FIG. 5 is a block diagram showing an arrangement of the first communication system.

FIG. 6 is a block diagram showing an arrangement of a second communication system.

FIG. 7 is a block diagram showing an arrangement of the communication system.

FIG. 8 illustrates a subscriber information table.

FIG. 9 illustrates a summary of an optical access system.

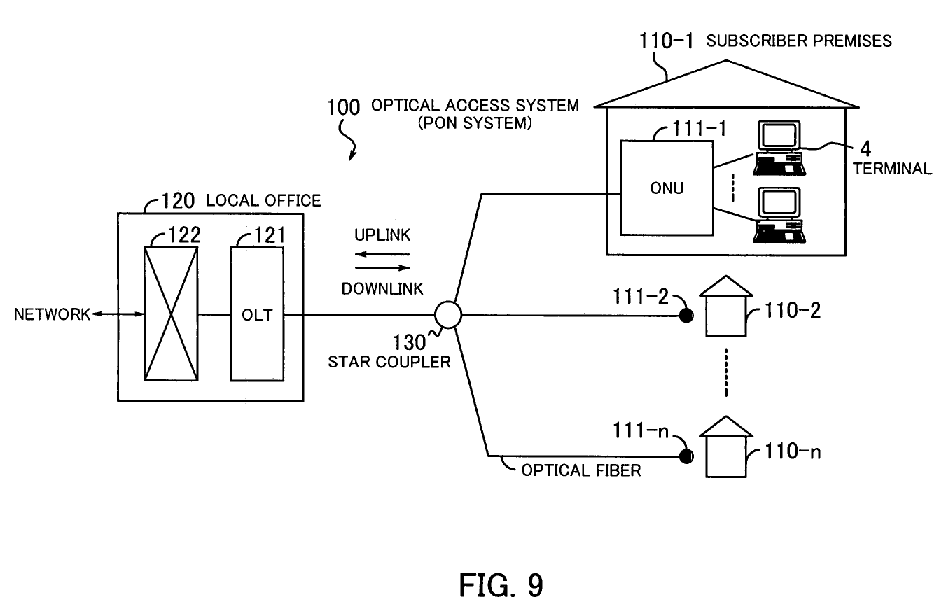

### DESCRIPTION OF THE PREFERRED EMBODIMENTS

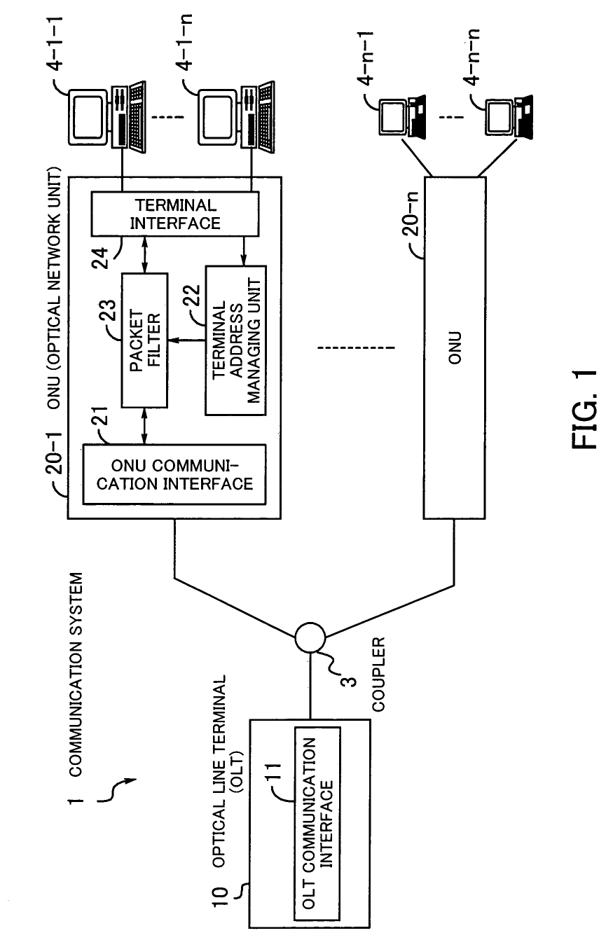

Hereafter, the embodiments of the present invention will be described with reference to the appended drawings. FIG. 1 is a principle view showing a communication system according to the present invention. A communication system 1 is a system for communicating between a local office and each of subscribers. Hereafter, the communication system 1 will be described with an example of an optical access system of the EPON.

In the communication system 1, ONUs 20-1 to 20-n (generally termed as an ONU 20) are connected with a plurality of terminals 4-1-1 to 4-1-n and 4-n-1 to 4-n-n (generally termed as a terminal 4) respectively. The ONUs 20-1 to 20-n are connected with an OLT 10 through a coupler 3 so that the PON permits the variable-length packets (frames) to be communicated on the Ethernet.

The OLT 10 includes an OLT communication interface 11. The OLT communication interface 11 transfers packets between the local office and the subscriber. Further, the interface 11 also transmits the filter-setting data to the ONU 20 or receives the filter-state data from the ONU 20.

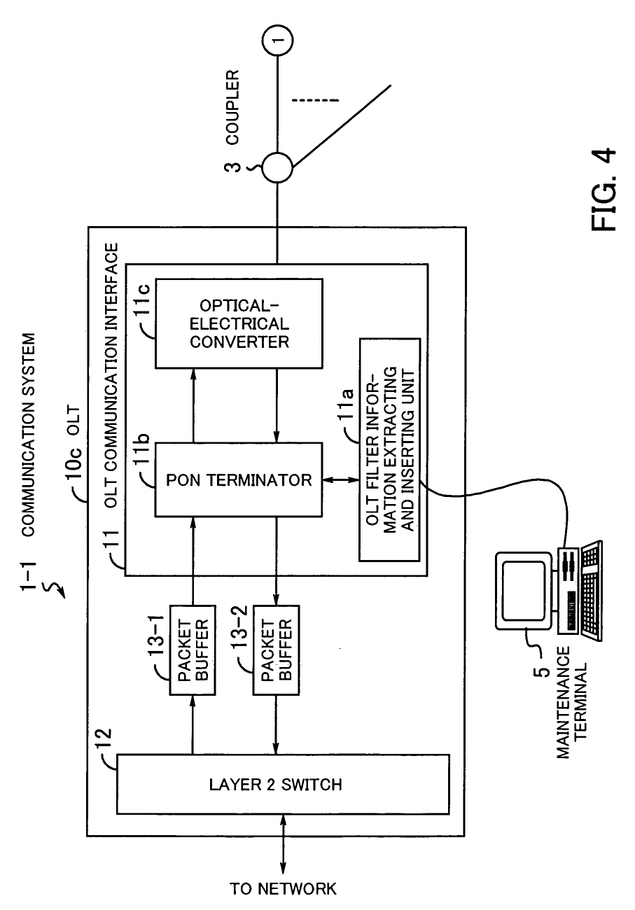

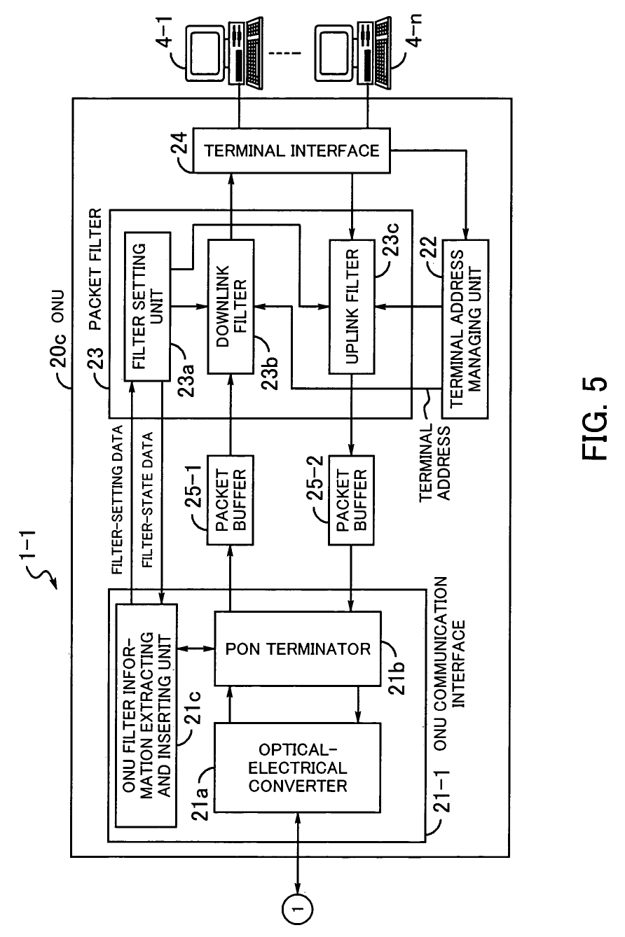

The filter-setting data means data transmitted for remotely setting a function of filtering packets in the ONU 20 by the OLT 10. The filter-state data means data received for indicating a setting state of the packet filtering function in the ONU 20 (to be discussed below with reference to FIGS. 4 and 5).

On the other hand, the ONU 20 is composed of an ONU communication interface 21, a terminal address managing unit 22, a packet filter 23 and a terminal interface 24. The ONU communication interface 21 transfers packets between the local office and the subscriber, receives the filter-setting data and transmits the filter-state data.

The terminal address managing unit 22 obtains a terminal address from a terminal connected with the concerned ONU itself and manages the terminal address. The packet filter 23 filters the packets transmitted from the OLT 10 to the terminal 4 based on at least one of deliverly information, registered information, and the filter-setting data. Concretely, the packet filter 23 operates to retrieve if the destination addresses contained in the packets transmitted from the OLT 10 are matched to the terminal addressed managed by the terminal address managing unit 22. If any address is matched, the packet filter 23 permits the packets to pass to the concerned terminal 4, while if no address is matched, the packet filter 23 discards the packets (does not permit the packets to pass). (Though the address is used for identifying the terminal, any information may be used if it is effective in identifying the terminal.)

It is assumed that the foregoing filtering operation is executed in the case that the delivery information is a unicast delivery pattern or in the case that no indication of blocking the filter is included in the filter-setting data. The details will be discussed later.

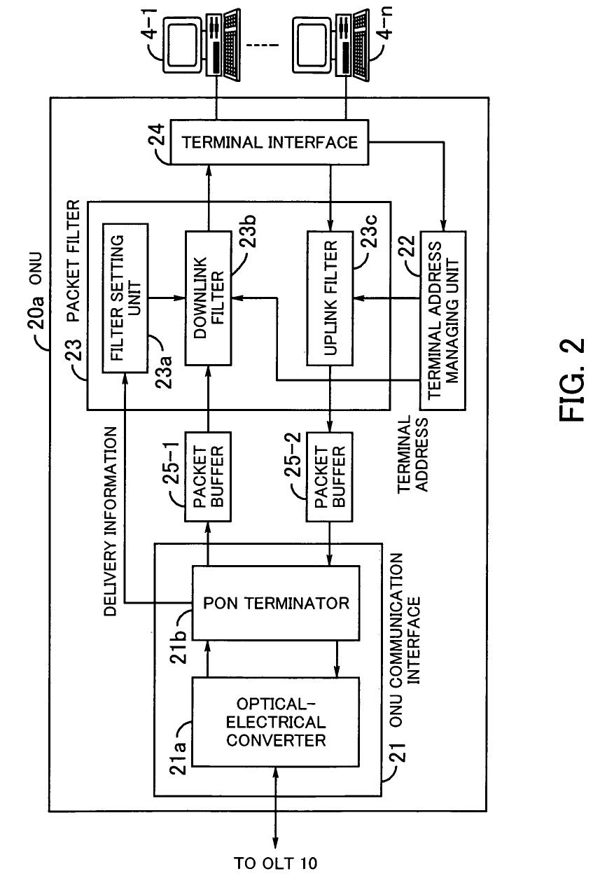

In turn, the description will be turned to the arrangement and the operation of the ONU 20. FIG. 2 shows an arrangement of a first ONU. An ONU 20a is connected with terminals 4-1 to 4-n and is composed of the ONU communication interface 21, the terminal address managing unit 22, the packet filter 23, and the terminal interface 24, and packet buffers 25-1 and 25-2. Further, the ONU communication interface 21 includes an optical-electrical converter 21a and a PON terminator 21b. The packet filter 23 includes a filter setting unit 23a, a downlink filter 23b and an uplink filter 23c.

The downstream operation from the local office to the subscriber will be described below. (As to the EPON, the variable-length packets are transmitted downstream from the local office to the subscriber on the timing optionally allocated to the subscriber by the local office.) The optical-electrical converter 21a receives a PON layer light signal and then converts the light signal into an electric signal.

The PON terminator 21b terminates the PON layer, extracts the packets, converts the packets according to the corresponding format with the ONU, and then writes the packets in the packet buffer 25-1. Further, the PON terminator 21b extracts the delivery information (to be discussed below) from the packets and transmits the delivery information to the filter setting unit 23a.

The terminal address managing unit 22 monitors the packets transmitted from the terminals 4-1 to 4-n connected therewith through the terminal interface 24, obtains a terminal address value from the packet, and then registers the terminal address value in a table.

In this registration, the obtained terminal address value is collated with the saved table value. If no matched value is included in the table and the obtained terminal address value is equal to the address value of the communication-enabled terminal, it is determined that the terminal is newly connected, and the terminal address is newly saved and managed in the table. (The terminal address managing unit 22 knows in advance the address values of the communication-enabled terminals that can be connected with the ONU 20a and communicate data with the local office and thus performs the registering process in the table in the known value range.)

The filter setting unit 23a performs a filtering setting to the downlink filter 23b based on the delivery information sent from the PON terminator 21b. Herein, the delivery information includes delivery patterns of multi/broadband cast and unicast. (The term “multi/broadcast” means delivery of the same packets to all the terminals 4-1 to 4-n. The term “unicast” means delivery of the packets to any one of the terminals 4-1 to 4-n.)

Concretely, if a 6-byte destination MAC (Media Access Control) address is set to 1 for all the bytes (or an odd number on the second byte), the MAC address indicates the packet of the multi/broadband cast. Hence, the filter setting unit 23a accepts a notice of this address from the PON terminator 21b and then issues an instruction of permitting all the packets to pass to the downlink filter 23b.

On the other hand, if the destination MAC address has an ordinary address value (unicast) that does not concern with the multi/broadband cast, the filter setting unit 23a issues an instruction of performing a filtering operation to the downlink filter 23b based on the comparison between the destination address and the terminal address.

The downlink filter 23b reads packets out of the packet buffer 25-1. If the delivery pattern of the delivery information is the multi/broadcast pattern, the downlink filter 23b performs a filtering operation of permitting the received packets to pass to the terminal side. Further, if the delivery pattern is the unicast pattern, the downlink filter 23b permits only the packets in which the destination address is matched to the terminal address to pass to the terminal side and discards the other packets. For the multi/broadcast pattern, the terminal interface 24 transmits the packets passed through the downlink filter 23b to all the terminals 4-1 to 4-n. For the unicast pattern, the downlink filter 23b permits the passed packets to transmit to one concerned terminal.

On the Ethernet, ordinarily, the multicast is not distinguished from the broadcast. Hence, though two delivery patterns of the multi/broadcast and the unicast are indicated in the foregoing description, by adding the information of distinguishing the multicast from the broadcast to the packet on the side of the OLT 10, it is possible to realize the three delivery patterns of the multicast, the broadcast and the unicast.

In this case, for the arrangement shown in FIG. 2, the multicast is defined as delivery of all the same packets to all the terminals 4-1 to 4-n, and the broadcast is defined as delivery of the packets to all the terminals belonging to the concerned broadband group if the terminals 4-1 to 4-n are divided into some broadband groups.

The downlink filter 23b is operated in the same manner as the above. That is, the downlink filter 23b permits all the packets of the multicast and the broadcast to pass therethrough, while for the packets of the unicast, the filter 23b permits only the packets in which the destination address is matched to the terminal address to pass therethrough and discards the other packets.

For the packets of the multicast, the terminal interface 24 allows all the packets passed through the downlink filter 23b to be transmitted to all the terminals 4-1 to 4-n. For the packets of the broadcast, the terminal interface 24 recognizes the broadband group to which the packets are to be transmitted and then allows the packets to be transmitted to all the terminals belonging to the concerned broadband group. For the packets of the unicast, the terminal interface 24 allows the passed packets to be transmitted to one concerned terminal.

In turn, the description will be turned to the upstream operation from the subscriber to the local office. (For the upstream transmission of the EPON from the subscriber to the local office, the variable-length packets are transmitted on the timing specified by the local office.) When the terminal interface 24 receives the packets from the terminals 4-1 to 4-n, the terminal interface 24 transmits the packets to the uplink filter 23c.

The uplink filter 23c permits the packet to pass therethrough and write the packet in the packet buffer 25-2 if the original transmitting address of the packet is equal to the terminal address saved in the terminal address managing unit 22, while the uplink filter 23c discards the packet if the former address is not equal to the latter one. (If the original transmitting address is not equal to the terminal address, the uplink filter 23c assumes that the connected terminal has no communication permission and disables the communication.)

The PON terminator 21b reads the packets from the packet buffer 25-2, converts the packets according to the format on the local office side. The optical-electrical converter 21a converts the received packets into the PON layer light signal and then transmits the light signal into the OLT 10.

As set forth above, the present invention is arranged so that in the ONU 20 installed in the previous stage to the terminal 4, the packet filter 23 may filter unnecessary packets. This arrangement prevents unnecessary packets from being delivered to the terminal 4 and thereby prevents the disadvantageous occupation of the transmission band of the network between the ONU 20 and the terminal 4 by the unnecessary packets. Further, the foregoing filtering operation is carried out according to the delivery patterns such as the multicast, the broadband cast and the unicast. This makes it possible to realize the quite flexible packet delivery.

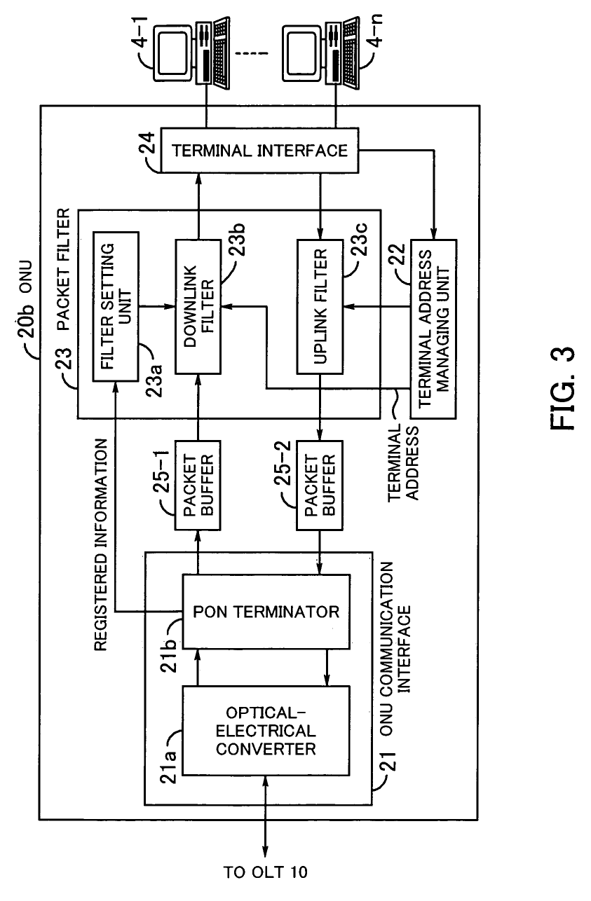

Next, the description will be turned to an embodiment in which the packets are filtered on the registered information. FIG. 3 illustrates an arrangement of a second ONU. The arrangement of an ONU 20b is the same as the arrangement shown in FIG. 2 except that the registered information is transmitted from the PON terminator 21b to the filter setting unit 23a.

The downstream operation from the local office to the subscriber will be described below. (Since the operation of each component has been described above, only the part about the registered information will be described hereafter. In addition, since the upstream operation is the same as the foregoing operation, it is not described herein.) The PON terminator 21b terminates the PON packet, when the PON terminator 21b determines if the ONU 20b is registered in the local office. If the packet output timing and the band allocation in the upstream transmission are specified by the OLT 10, it is determined that the concerned terminator 20b is registered in the local office. Then, the PON terminator 21b transmits to the filter setting unit 23a the registered information containing the determined result, that is, the registration or non-registration.

If the filter setting unit 23a recognizes that the concerned terminator is not registered on the basis of the registered information, the filter setting unit 23a issues to the downlink filter 23b an instruction of discarding all the received packets. Further, if it is recognized that the concerned terminator is registered in the local office on the basis of the registered information, the filter setting unit 23a issues an instruction of performing a filtering operation to the downlink filter 23b on the basis of the comparison between the destination address and the terminal address.

As described above, according to the present invention, by performing the filtering operation of discarding the packets if not registered or passing the packets if registered, it is possible to prevent wasteful delivery of unnecessary packets to the terminal 4.

In turn, the description will be turned to an embodiment in which the packets are filtered on the filter-setting data. FIGS. 4 and 5 illustrate an arrangement of a first communication system. As a communication system 1-1, the arrangement of an OLT 10c is shown in FIG. 4 and an ONU 20c is shown in FIG. 5.

The OLT 10c is composed of an OLT communication interface 11, a layer 2 switch 12 and packet buffers 13-1 and 13-2. The OLT communication interface 11 includes an OLT filter information extracting and inserting unit 11a, the PON terminator 11b and the optical-electrical converter 11c.

The layer 2 switch 12 performs a switching operation of the upstream packets to the network and the downstream packets to the network. The packet buffer 13-1 accumulatively stores the packets to be transmitted to the subscriber, while the packet buffer 13-2 accumulatively stores the packets to be transmitted to the network.

The optical-electrical converter 11c converts the light PON packets into an electric signal or the electric PON packet into a light signal. The PON terminator 11b converts the format of the packets transmitted from the subscriber to the local office or the format of the packets transmitted vice versa as the terminating process.

The OLT filter information extracting and inserting unit 11a generates the filter-setting data of setting the downlink filter 23b and the uplink filter 23c located in the ONU 20c remotely from the local office and then transmits the filter-setting data to the PON terminator 11b. The filter-setting data is then transmitted to the ONU 20c through the PON terminator 11b and the optical-electrical converter 11c. At a time, the extracting and inserting unit 11a receives the filter-state data transmitted from the ONU 20c through the PON terminator 11b. If the extracting and inserting unit 11a is connected with a maintenance terminal 5, the unit 11a may be controlled by an operator so that it may set or read the filtering condition.

On the other hand, the ONU 20c further includes an ONU communication interface 21-1 installed therein. The interface 21-1 includes an ONU filter information extracting and inserting unit 21c. The extracting and inserting unit 21c receives the filter-setting data transmitted from the OLT 10c through the PON terminator 21b and then notifies the filter setting unit 23a of the data. Further, the extracting and inserting unit 21c receives the filter-state data from the filter setting unit 23a. The filter-state data indicates the filter-setting contents (current operating state of the filter) of the downlink filter 23b and the uplink filter 23c. The filter-state data is transmitted to the OLT 10c through the PON terminator 21b and the optical-electrical converter 21a.

Herein, the description will be turned to the filtering operation to be executed when the filter-setting data includes information of blocking the filtering (disallowing the data to pass therethrough). The OLT filter information extracting and inserting unit 11a generates the filter-setting data including the information of blocking the filtering (for example, blocking the downlink filter 23b). The filter-setting data is transmitted to the ONU 20c through the PON terminator 11b and the optical-electrical converter 11c.

Then, the filter-setting data passes the optical-electrical converter 21a and the PON terminator 21b and reaches the ONU filter information extracting and inserting unit 21c, in which the data is extracted. The extracted data is sent to the filter setting unit 23a. If the filter setting unit 23a recognizes the blocking as the contents of the filter-setting data, the filter setting unit 23a issues a blocking instruction to the downlink filter 23b. In response to the blocking instruction, the downlink filter 23b discards all the received packets. (In this case, even if the destination of the packet is matched to the terminal address, the packets are discarded.)

In the foregoing embodiment, the downlink filter 23b was set to block the packets. Instead, the uplink filter 23c is set to block the packets transmitted from the terminal 4. Moreover, both of the filters may be set to block the packets.

Further, the OLT filter information extracting and inserting unit 11a is served to receive the filter-state data transmitted from the ONU 20c and display the filter-state data on the maintenance terminal 5. Hence, an operator enables to constantly monitor the states of the downlink filter 23b and the uplink filter 23c (for example, whether or not the filter stays in the blocking state).

The control signals such as the filter-setting data and the filter-state data are transmitted at empty intervals appearing while the main signal, that is, the packets are being transmitted. Hence, if the traffics of the packets are too large, the transmission of the filter-setting data and the filter-state data is avoided.

Hence, if the current storage of the packet buffer 13-1 is less than a predetermined value that is a critical value to data overflow, the OLT filter information extracting and inserting unit 11a determines that the traffics of the downstream packets are not overcrowded and thus transmits the filter-setting data to the ONU 20c. Likewise, the ONU filter information extracting and inserting unit 21a determines that the traffics of the upstream packets are not overcrowded if the current storage of the packet buffer 25-2 is less than the predetermined value that is a critical value to data overflow. Then, the filter-state data is transmitted to the OLT 10c.

As set forth above, the present invention provides a capability of allowing the OLT 10c to set the filtering contents of the ONU 20c so that an operator may remotely manage the filtering contents. Therefore, the present invention enables to prevent delivery of unnecessary packets to the terminal 4, simplify the maintenance, and improve reliability of the access network.

In turn, the description will be turned to an embodiment in which the local office does not transmit unnecessary packets. In the foregoing description, the delivery of unnecessary packets is prevented by executing the filtering on the subscriber side. In the following description, the local office generates such packets as allowing the subscriber to recognize that the packets are sent to the subscriber itself and then transmits such packets.

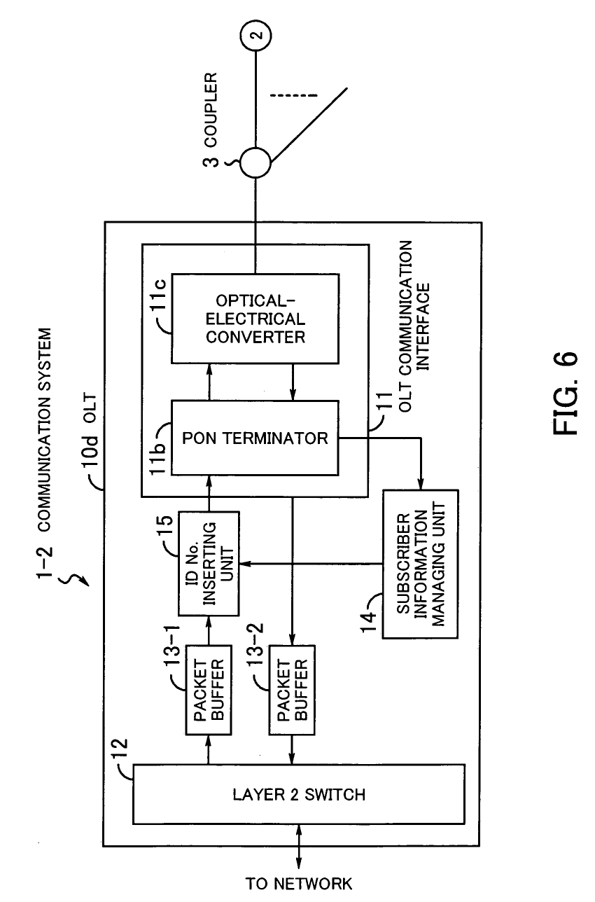

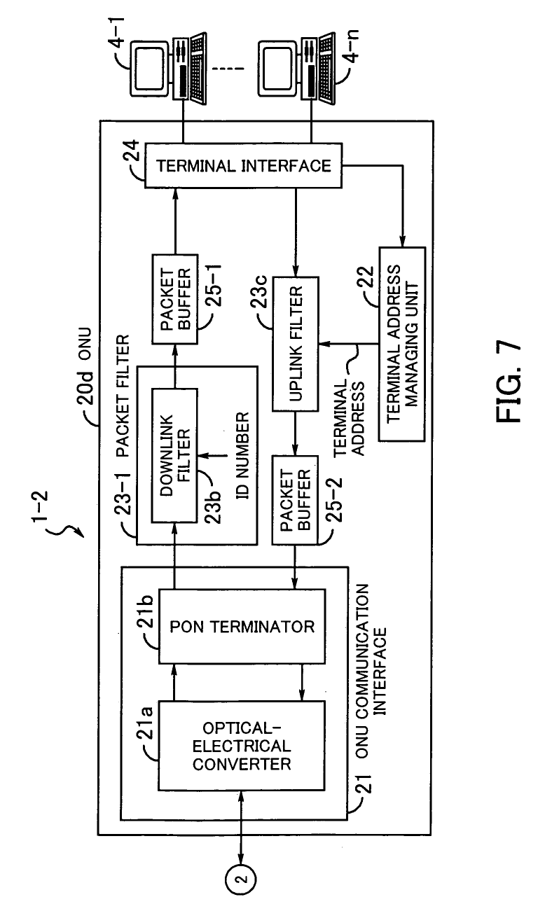

FIGS. 6 and 7 illustrate an arrangement of a second communication system. For a communication system 1-2, FIG. 6 shows an arrangement of an OLT 10d and FIG. 7 shows an arrangement of an ONU 20d.

The OLT 10d is composed of an OLT communication interface 11, a layer 2 switch 12, packet buffers 13-1 and 13-2, a subscriber information managing unit 14, and an ID inserting unit 15. The OLT communication interface 11 includes a PON terminator 11b and an optical-electrical converter 11c.

The description will be turned to the subscriber information managing unit 14 and the ID inserting unit 15. The subscriber information managing unit 14 manages the subscriber information transmitted from the ONU 20d. The subscriber information is composed of an ID number of the ONU 20d and an address of each terminal connected with the ONU 20d.

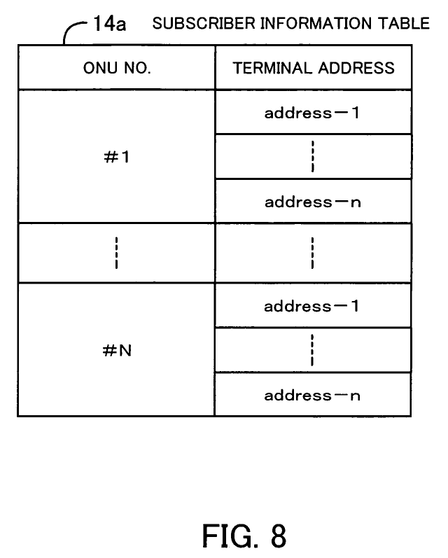

FIG. 8 illustrates a subscriber information table, which is managed in the subscriber information managing unit 14. In the table is noted a correspondence between an ID number of the ONU and a terminal address.

The subscriber information managing unit 14 retrieves the subscriber information table 14a about the terminal to which the local office is scheduled to transmit packets with the terminal address and obtains the ID number of the target ONU. The ID number inserting unit 15 inserts the ID number to the packet and then transmits the packet to the subscriber.

The ONU 20d shown in FIG. 7 is composed of an ONU communication interface 21, a terminal address managing unit 22, a packet filter 23-1, an uplink filter 23c, a terminal interface 24, and packet buffers 25-1 and 25-2. The ONU communication interface 21 includes an optical-electrical converter 21a and a PON terminator 21b. The packet filter 23-1 includes a downlink filter 23b.

The ONU communication interface 21 transmits the subscriber information of the concerned device (composed of an ID number of the ONU and an address of a connected terminal) to the OLT 10d. The packet filter 23-1 having the downlink filter 23b permits only the packets with the same ID number as that of the concerned subscriber to pass to the terminal.

In the foregoing description, according to the present invention, the OLT 10d adds an ID number of the ONU 20d to the packet and then transmits the packet. The ONU 20d is arranged to permit only the packets with the same ID number as that of the concerned subscriber to pass therethrough. This makes it possible to prevent delivery of unnecessary packets to the terminal.

The foregoing description has been expanded in the case of applying the present invention to the EPON. The present invention may be applied not only to the optical access system represented by the EPON but also to a variety of application systems that require such a filtering function as preventing unnecessary packets from being passed to a processing unit located at a later stage.

As set forth above, in the communication system according to the present invention, the ONU retrieves if a destination address included in the packets transmitted from the OLT is matched to the terminal address managed by the terminal address managing unit based on the filter-setting data, and if any address is matched, permits the packets to pass to the concerned terminal or if no address is matched, discards the packets. This makes it possible to avoid unfavorable occupation of the transmission band by unnecessary packets by preventing unnecessary packet from being delivered down to the terminal.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A communication system for communicating information, comprising:
an optical line terminal having an OLT communication interface for transferring packets between a local office and a subscriber or transmitting filter-setting data and receiving filter-state data; and
an optical network unit having an ONU communication interface for transferring packets between the local office and the subscriber or receiving the filter-setting data and transmitting the filter-state data, a terminal address managing unit for obtaining and managing a terminal address from a connected terminal, and a packet filter for filtering packets transmitted from the optical line terminal with respect to the terminal based on at least one of delivery information, registered information, and the filter-setting data.

2. The communication system according to claim 1, wherein the packet filter retrieves if a destination address included in the packet transmitted from the optical line terminal is matched to the terminal address managed by the terminal address managing unit and performs a filtering operation of, if any destination address is matched, permitting the packet to pass to the terminal or if no destination address is matched, discarding the packet.

3. The communication system according to claim 1, wherein the packet filter permits packets to pass to all the terminals if the packet filter recognizes packet delivery formats of multicast and broadcast as the delivery information.

4. The communication system according to claim 1, wherein if the packet filter recognizes receipt of a packet destined for a subscriber not registered in the local office based on the registered information, the packet filter discards the packet and permits only the packet destined for a subscriber registered in the local office to pass therethrough.

5. The communication system according to claim 1, wherein the OLT communication interface transmits the filter-setting data having information of blocking the filtering operation to the optical network unit and when the packet filter receives the filter-setting data, even if the destination address of a packet is matched to the terminal address, the packet filter discards the packet.

6. The communication system according to claim 1, wherein if the storage amount of a packet buffer used for transmitting packets to the optical network unit is less than a predetermined value that is a critical value to data overflow, the OLT communication interface transmits the filter-setting data, and if the storage amount of a packet buffer used for transmitting packets to the optical line terminal is less than a predetermined value that is a critical value to data overflow, the ONU communication interface transmits the filter-state data.

7. An optical line terminal for communicating information, comprising:
an OLT communication interface for transferring packets between a local office and a subscriber or transmitting filter-setting data including information of blocking a filtering operation on the subscriber end and receiving filter-state data from the subscriber; and
a packet buffer for storing packets when transferring the packets.

8. The optical line terminal according to claim 7, wherein if the storage amount of the packet buffer is less than a predetermined value that is a critical value to data overflow, the OLT communication interface transmits the filter-setting data.

9. An optical network unit for communicating information, comprising:
an ONU communication interface for transferring packets between a local office and a subscriber or receiving filter-setting data from the local office and transmitting filter-state data to the local office;
a terminal address managing unit for obtaining and managing a terminal address from a connected terminal;
a packet filter for performing a filtering operation of packets transmitted from the local office with respect to the terminal on the basis of at least one of delivery information, registered information and the filter-setting data; and
a packet buffer for storing packets when transferring packets.

10. The optical network unit according to claim 9, wherein the packet filter retrieves if a destination address included in the packet transmitted from the local office is matched to the terminal address managed by the terminal address managing unit, if any address is matched, permits the packet to pass to the terminal, or if no address is matched, discards the packet.

11. The optical network unit according to claim 9, wherein if the packet filter recognizes a packet delivery format of multicast or broadcast as the delivery information, the packet filter permits the packets to pass to all the terminals.

12. The optical network unit according to claim 9, wherein if the packet filter recognizes receipt of a packet destined for a subscriber not registered in the local office on the basis of the registered information, the packet filter discards the packet and permits only a packet destined for a subscriber registered in the local office to pass therethrough.

13. The optical network unit according to claim 9, wherein when the packet filter receives the filter-setting data including information of blocking a filtering operation, even if a destination address of a packet is matched to the terminal address, the packet filter discards the packet.

14. The optical network unit according to claim 9, wherein if the storage amount of the packet buffer used for transmitting packets to the local office is less than a predetermined value that is a critical value to data overflow, the ONU communication interface transmits the filter-state data.

15. A communication system for communicating information, comprising:
an optical line terminal having a subscriber information managing unit for managing subscriber information that indicates correspondence between an ID number and an address of a connected terminal and an OLT communication interface for transferring packets between the local office and the subscriber so that a packet with the ID number inserted therein may be transmitted; and
an optical network unit having an ONU communication interface for transferring packets between the local office and the subscriber and transmitting subscriber information and a packet filter for performing a filtering operation of permitting only the packet with the same ID number as that of the subscriber to pass to the terminal.

16. An optical line terminal for communicating information, comprising:
a subscriber information managing unit for managing subscriber information that indicates correspondence between an ID number and an address of a connected terminal; and
an OLT communication interface for transferring packets between the local office and the subscriber so that a packet with the ID number inserted therein may be transmitted.

17. An optical network unit for communicating information, comprising:
an ONU communication interface for transferring packets between a local office and a subscriber and transmitting subscriber information that indicates correspondence between an ID number and an address of a connected terminal; and
a packet filter for performing a filtering operation of permitting only the packet with the same ID number as that of the subscriber inserted therein to pass to the terminal.

18. An optical access system for making a subscriber communication network an optical network and communicating variable-length packets, comprising:
an optical line terminal having an OLT communication interface for transferring a local office and a subscriber or transmitting filter-setting data and receiving filter-state data;
an optical network unit having an ONU communication interface for transferring packets between the local office and the subscriber or receiving the filter-setting data and transmitting the filter-state data, a terminal address managing unit for obtaining and managing a terminal address from a connected terminal, and a packet filter for performing an operation of filtering packets transmitted from the optical line terminal with respect to the terminal based on at least one of delivery information, registered information and the filter-setting data; and
a coupler for connecting the optical line terminal with the optical network unit at a ratio of 1:n.

19. The optical access system according to claim 18, wherein the packet filter retrieves if a destination address included in the packet transmitted from the optical line terminal is matched to the terminal address managed by the terminal address managing unit, if any address is matched, permitting the packet to pass to the concerned terminal, and if no address is matched, performing a filtering operation of discarding the packet.

20. The optical access system according to claim 18, wherein if the packet filter recognizes a packet delivery format of multicast or broadband cast as delivery information, the packet filter permits packets to pass to all the terminals.

21. The optical access system according to claim 18, wherein if the packet filter recognizes receipt of a packet destined for a subscriber not registered in the local office, the packet filter discards the packet and permits only the packet for destined for a subscriber registered in the local office.

22. The optical access system according to claim 18, wherein the OLT communication interface transmits to the optical network unit the filter-setting data including information of blocking a filtering operation, and when the packet filter receives the filter-setting data, even if the destination address of the packet is matched to the terminal address, the packet filter discards the packet.

23. The optical access system according to claim 18, wherein if the storage amount of a packet buffer used for transmitting packets to the optical network unit is less than a predetermined value that is a critical value to data overflow, the ONU communication interface transmits the filter-setting data, and if the storage amount of a packet buffer used for transmitting packets to the optical line terminal is less than a predetermined value that is a critical value to data overflow, the ONU communication interface transmits the filter-state data.

24. An optical access system for making a subscriber communication network an optical network and communicating variable-length packets, comprising:
an optical line terminal having a subscriber information managing unit for managing subscriber information that indicates correspondence between an ID number of an optical network unit and an address of a connected terminal and an OLT communication interface for transferring packets between a local office and a subscriber so that the packet with the ID number inserted may be transmitted;
an optical network unit having an ONU communication interface for transferring packets between the local office and the subscriber and transmitting subscriber information and a packet filter for performing a filtering operation of permitting only the packet with the same ID number as that of the subscriber inserted therein to pass to the terminal; and
a coupler for connecting the optical line terminal with the optical network unit at a ratio of 1:n.
